(19) United States
(12) Patent Application Publication
(10) Pub. No.: US 2026/0316480 A1
(43) Pub. Date: Oct. 15, 2026

(54) OPTICALLY VARIABLE SECURITY ELEMENT WITH MACHINE-READABLE FEATURE SUBSTANCE AND OPTICAL FUNCTIONAL LAYER, VALUE DOCUMENT AND EXAMINATION METHOD

(71) Applicant: GIESECKE+DEVRIENT CURRENCY TECHNOLOGY GMBH, Munchen (DE)

(72) Inventors: Thomas HAPP, Munchen (DE); Winfried HOFFMULLER, Gmund am Tegernsee (DE); Andreas RAUCH, Gmund am Tegernsee (DE)

(21) Appl. No.: 19/491,514

(22) PCT Filed: May 17, 2024
(86) PCT No.: PCT/DE2024/100465

§ 371 Date: Dec. 9, 2025

(30) Foreign Application Priority Data
Jun. 20, 2023 (DE) 10 2023 116 133.4

(51) Int. Cl. B42D 25/29; B42D 25/328; B42D 25/382

(52) U.S. Cl. CPC B42D 25/29; B42D 25/328; B42D 25/382

(57) ABSTRACT

An optically variable security element for protecting a document of value has a first machine-readable feature material and an optical functional layer, which imparts an optically variable appearance to the security element when viewed. Provision is made that the security element is formed in multiple layers with an internal foil sheet, which has a first side and an opposite second side, the foil sheet being provided at least on the first side with an adhesive layer for connection to the document of value and on the second side with the optical functional layer, and the first machine-readable feature material being arranged in the foil sheet or on the second side of the foil sheet.

### BACKGROUND

The invention relates to an optically variable security element for protecting a document of value, having a machine-readable feature material and an optical functional layer, which imparts an optically variable appearance to the security element when viewed. The invention also comprises a document of value having such a security element, as well as a method for verifying such a document of value.

Data carriers, such as documents of value or identification documents, as well as other objects of value, for instance proprietary articles, are often provided for protection with security elements which make it possible to verify the authenticity of the data carriers and at the same time serve as a safeguard against illegitimate reproduction.

It has been found that security elements are detached from genuine documents of value by counterfeiters during attempts at manipulation and applied onto an unauthorized document, or that the substrate of a genuine document of value is provided with a counterfeited security element after such a detachment process. This type of detachment attack is also referred to as “harvesting” and is often demonstrable as manipulation only with difficulty both visually and when using a machine.

Foil security elements often do not carry machine-readable features, so that the replacement of such a security element with a counterfeit is not readily demonstrable when using a machine. It has therefore been proposed in document WO 2023/285000 A1 to provide both the substrate of a banknote and an applied security element with security components which in combination provide a characteristic signal. The absence of the combination signal is then a strong indication that manipulation has taken place. There is, however, the risk that a part of the security component which generates the characteristic signal remains on the banknote substrate when a security element is detached, so that a combination signal is generated despite the manipulation and the manipulated note cannot reliably be recognized as a counterfeit.

On the basis thereof, the object of the invention is to provide a security element of the generic type which avoids the disadvantages of the prior art. In particular, the machine-readable feature material is intended to be removed fully from the original document during a detachment attack on a security element applied on a document. The invention is also intended to provide a document of value protected against detachment attacks and having such a security element, as well as a verification method for such protected documents of value.

### SUMMARY

The invention comprises an optically variable security element having a first machine-readable feature material and an optical functional layer, which imparts an optically variable appearance to the security element when viewed. The optically variable security element is used in particular to protect a document of value, for instance a banknote or an identification document.

As its special characteristic, the security element is formed in multiple layers with an internal foil sheet, which has a first side and an opposite second side, the foil sheet being provided at least on the first side with an adhesive layer for connection to the document of value and on the second side with the optical functional layer. The first machine-readable feature material is arranged in the foil sheet or on the second side of the foil sheet. The arrangement on the second side of the foil sheet may take place either directly on the surface of the second side of the foil sheet or alternatively in a layer on the second side that is separated from the surface of the foil sheet by further intermediate layers.

In this description, the first side of the foil sheet is sometimes also referred to as the “lower side” and the second side as the “upper side” since, particularly in the case of security elements adhesively bonded onto a target document, often the first side is connected to the target document and the second side faces toward the observer. A security element may nevertheless also be arranged in a recessed or transparent region of the target document and be configured for viewing from both sides. In the case of security elements, for instance security threads, partially or fully embedded into a target substrate, both the first side and the second side may be exposed in window regions and face toward the observer. Here as well, the security threads, for example in the case of rolling security threads, may be observable from both sides. The terms lower side and upper side are therefore not to be understood as restrictive in the following description.

After the security element according to the invention has been adhesively bonded onto a target document or introduced into a target document, the location of the feature material ensures that the feature material is removed fully together with the optical functional layer in the event of a detachment attack and no feature material residue remains on or in the target document. Without wishing to be restricted to a particular explanation, according to current understanding the internal foil sheet stabilizes the overlying or underlying layers of the security element to such an extent that the foil sheet is also detached as well during detachment of the optical functional layer. Since the machine-readable feature material is arranged in or over the foil sheet, it is also detached fully during this process without leaving residues on or in the target document. In other words, the optical functionality of the security element can only be detached or removed from a document together with the entire feature material.

In one advantageous embodiment, the first machine-readable feature material is an IR luminescent material or an optical storage phosphor with optically stimulated luminescence.

The first machine-readable feature material is present in one advantageous embodiment in a feature layer arranged on the second side of the foil sheet, particularly in a UV-curable varnish layer, an embossing varnish layer or an adhesive layer, for example a laminating adhesive layer.

Particularly advantageously, the layer containing the first machine-readable feature material is the optical functional layer itself, a part of the optical functional layer or is connected directly to the optical functional layer. For example, the optical functional layer may contain an embossing varnish layer provided with a relief structure and the first machine-readable feature material may be introduced into the embossing varnish layer. In another embodiment, the first machine-readable feature material may be present in an adhesive layer by which the optical functional layer is connected to the foil sheet. The first machine-readable feature material may also be present in its own dedicated feature layer, which in particular is arranged between the foil sheet and the optical functional layer. In addition, the first machine-readable feature material may also be present in the foil sheet itself.

The foil sheet is advantageously formed by a foil with a thickness of between 4 μm and 15 μm and is for example a PET foil.

In one advantageous embodiment, the optical functional layer is formed by a hologram or another diffraction structure, an interference structure, a matt structure, a micromirror arrangement, a microlens arrangement, a moth-eye structure, a subwavelength structure or a combination of these elements.

Advantageously, the optical functional layer has a reflection-increasing coating, in particular a metal layer, for example of Al, Cr, Fe, Ni, Cu, Fe:Si, or alloys of these materials, a high-index layer, such as TiO₂ or ZnS, and/or a color-shifting interference layer structure. The interference layer structure may in particular be formed from a color-shifting thin-film element having the layer sequence: absorber/dielectric/reflector, for example Cr/SiO₂/Al or Al/SiO₂/Al.

The reflection-increasing coating may be provided with transparent and/or semitransparent regions by suitable methods. For example, to this end a washing method, structuring using resist varnish and an etching step, or local laser ablation or laser modification of the reflection-increasing coating may be envisioned.

According to one preferred embodiment, the first machine-readable feature material is an IR luminescent material which has an emission in the near-infrared spectral range, particularly in the wavelength range of between 800 nm and 2100 nm and/or can be excited in the wavelength range of between 400 nm and 2100 nm, preferably in the wavelength range of between 700 nm and 2100 nm.

In another likewise advantageous embodiment, the first machine-readable feature material is an optical storage phosphor with optically stimulated luminescence. The functionality of such optical storage phosphors is described in more detail for example in document DE 10 2017 008 868 A1. Charging the optical storage phosphor preferentially takes place in the wavelength range of 350 nm-550 nm, preferentially in the VIS (visible) wavelength range of 400-550 nm, and the readout preferentially takes place in the VIS or IR wavelength range of 550 nm-1000 nm.

An optical storage phosphor is advantageously used as the first machine-readable feature material particularly when the feature material is arranged on the second side of the foil sheet above any present metal layers, since readout of the feature material is then readily possible in the VIS or even UV spectral range.

According to one development of the invention, the security element contains one or more further functional layers having further authenticity features such as fluorescence, IR, magnetism, conductivity, polarization effects, colored inks and/or effect inks. The functional layers may be present surface-wide or structured. Optically effective functional layers are advantageously covered at most partially by a reflection-increasing coating of the security element, in particular an opaque reflection-increasing coating.

Delicate layers may optionally be protected by laminating a foil. The foil to be laminated may carry any further layers among those mentioned. If light-absorbing layers are used, it may be advantageous to employ a reflector placed optically on the rear side, for example a layer of Supersilver or in the form of a metallization, in order to reduce the visibility after embedding into the paper.

According to one advantageous variant of the invention, the security element is a security thread, in particular a window security thread or a rolling security thread. Such a security thread can be applied to a document of value; it is, however, advantageously embedded partly or completely into a document of value. According to another likewise advantageous variant of the invention, the security element is a patch or label for application onto a document of value.

If the security element is a security thread at least partially embedded into a paper substrate, the embedding into the paper may be improved by the use of heat-sealing varnishes on both thread surfaces. The adhesion of the heat-sealing varnishes to the thread may be increased by the use of primers. In general, it may be necessary to improve the adhesion of layers by the use of primers.

If the security thread contains micro-optical systems with microlenses, for instance a moiré magnification arrangement, a heat-sealing varnish sometimes cannot be used on the upper side (lens side) of the thread. This disadvantage may be avoided by the use of high-index and low-index varnish systems (for embossing/embedding), so that it is still possible to use primer and heat-sealing varnish.

The invention also comprises a document of value having an optically variable security element of the type described, wherein the optically variable security element is connected by the adhesive layer arranged on the first side (lower side) of the foil element to a substrate of the document of value. The substrate of the document of value contains a second machine-readable feature material, in particular an IR luminescent material or an optical storage phosphor with optically stimulated luminescence.

The invention further comprises a document of value having an optically variable security element of the type described, wherein the optically variable security element is a security thread embedded at least partially into the document of value, and wherein the substrate of the document of value contains a second machine-readable feature material, in particular an IR luminescent material or an optical storage phosphor with optically stimulated luminescence.

The security thread may in this case be connected to the substrate of the document of value via an adhesive layer, in particular a heat-sealing varnish layer, for good anchoring both on the first side and on the second side of the foil element. In window regions, the adhesive layer may be absent.

The substrate of the document of value in advantageous embodiments is a paper substrate or plastic substrate or a composite substrate consisting of at least one paper sheet and at least one plastic sheet.

Advantageously, the first and the second feature material is in each case an IR luminescent material, the first and second IR luminescent materials advantageously having different emission spectra and/or different excitation spectra.

In one advantageous variant of the invention, the first and the second IR luminescent material have at least one common spectral band in the emission spectrum and at the same time separate spectral bands in the excitation spectrum. This allows the respectively separate excitation with spectrally common detection and therefore a technically simpler detector, so that the two IR luminescent materials can be detected independently of one another.

In another likewise advantageous variant of the invention, the first and the second IR luminescent material have at least one common spectral band in the excitation spectrum and at the same time separate spectral bands in the emission spectrum. This allows the simultaneous excitation of the two IR luminescent materials, for example with a single light source, with separate detection in for example two different spectral channels in a single combination sensor, so that here again the two IR luminescent materials can be detected independently of one another.

The IR luminescent materials used in the scope of the invention may be organic or organometallic luminescent materials, for example fluorescent organic molecules or phosphorescent organometallic complexes. In one preferred embodiment, they are organometallic complexes. These generally exhibit narrower, more specific emission bands and a large Stokes shift. This facilitates excitation and detection. In particular, the separation of the emission radiation from the excitation radiation and from noise signals is facilitated. Preferentially, the organometallic complexes are rare-earth complexes, particularly preferentially rare-earth complexes of the rare earths neodymium, ytterbium, erbium, thulium, holmium or combinations of these of two or more rare earths.

In a further advantageous embodiment, one or both IR luminescent materials are an inorganic luminescent material. For example, they are doped inorganic host lattices. The dopants may furthermore be the rare earths neodymium, ytterbium, erbium, thulium, holmium or the transition metals vanadium, chromium, manganese, iron. Besides the aforementioned dopants, further dopants may also be present, for example in order to adjust the decay time of the luminescent material and/or to use energy transfers between the rare-earth ion and/or the transition metal and the further dopant. Suitable inorganic matrices are for example:
i) oxides, in particular trivalent and tetravalent oxides such as for example titanium oxide, aluminum oxide, iron oxide, boron oxide, yttrium oxide, cerium oxide, zirconium oxide, bismuth oxide, as well as more complex oxides such as for example garnets, including inter alia for example yttrium iron garnets, yttrium aluminum garnets, gadolinium gallium garnets; perovskites, including inter alia yttrium aluminum perovskite, lanthanum gallium perovskite; spinels, including inter alia zinc aluminum spinels, magnesium aluminum spinels, manganese iron spinels; or mixed oxides such as for example ITO (indium tin oxide);
ii) oxyhalides and oxychalcogenides, in particular oxychlorides such as for example yttrium oxychloride, lanthanum oxychloride; as well as oxysulfides, such as for example yttrium oxysulfide, gadolinium oxysulfide or yttrium gadolinium oxysulfide
iii) sulfides and other chalcogenides, for example zinc sulfide, cadmium sulfide, zinc selenide, cadmium selenide;
iv) sulfates, in particular barium sulfate and strontium sulfate;
v) phosphates, in particular barium phosphate, strontium phosphate, calcium phosphate, yttrium phosphate, lanthanum phosphate, as well as more complex phosphate-based compounds such as for example apatites, including inter alia calcium hydroxyapatites, calcium fluoroapatites, calcium chloroapatites; or spodiosites, including for example calcium fluorospodiosites, calcium chlorospodiosites;
vi) halides, in particular fluorides such as for example sodium rare-earth fluorides;
vii) silicates and aluminosilicates, in particular zeolites such as for example zeolite A, zeolite Y; zeolite-related compounds such as for example sodalites; feldspars such as for example alkali metal feldspars, plagioclases; and/or
viii) further inorganic compound classes such as for example vanadates, germanates, arsenates, niobates, tantalates.

According to a further variant of the invention, the first and the second feature material is in each case an optical storage phosphor, the first and second optical storage phosphor advantageously being chargeable together and readable differently. The latter simplifies the sensor and allows reliable separation of the two features via the readout.

For the second optical storage phosphor, the comments made above relating to the first optical storage phosphor apply similarly.

In the context of the present invention, the optical storage phosphors used may be substances such as suitably doped alkaline-earth sulfides (for example SrS: Eu,Sm), halides (for example BaFBr: Eu), aluminates (for example SrAl₂O₄:Eu,Tm or Sr₄Al₁₄O₂₅:Eu,Dy), oxides (for example MgO:Tb, BeO, Al₂O₃:C), garnets (for example Gd_{3.04}Al₂Ga₃O₁₂: Ce_{0.005}, Yb_{0.005} or Gd_{2.52}La_{0.5}Al₂Ga₃O₁₂:Ce_{0.04},Zr_{0.005}) or alternatively may be further materials which absorb energy in the form of UV or VIS radiation, store this energy and only release it again in the form of luminescence under deliberate stimulation. If light is used as the stimulus, this is referred to as optically stimulated luminescence. Further suitable optical storage phosphors are described in DE 10 2017 008 868A1, the disclosure of which to this extent is incorporated into the present application.

Lastly, in a further advantageous embodiment of the invention, one of the two feature materials can be an IR luminescent material and the other of the two feature materials can be an optical storage phosphor.

Particularly preferentially, the first feature material of the security element is an IR luminescent material and the second feature material of the document of value substrate is an optical storage phosphor with optically stimulated luminescence. The two luminescence markers are separated via the different emissions, and the excitation of the IR luminescent material may also advantageously be combined with the charging or the readout of the optical storage phosphor.

The invention lastly also comprises a method for verifying a document of value of the type described above, in which the presence of the first feature material in the optically variable security element and the presence of the second feature material in the substrate of the document of value are recorded with position resolution using a machine, and the recorded distributions of the first and second feature materials are compared with expected distributions. Based on the comparison result, the document of value may then be deemed authentic or it may be deduced that manipulation has taken place.

In one advantageous method variant, verification takes place on a document of value in which the first and the second feature material is in each case an IR luminescent material, and the two IR luminescent materials have at least one common spectral band in the excitation spectrum and at the same time separate spectral bands in the emission spectrum.

In this advantageous method variant, the substrate of the document of value and the security element are illuminated with excitation light which contains a wavelength of the common spectral band of the excitation spectrum of the first and of the second IR luminescent material, the light emissions of the first and of the second IR luminescent material are each recorded with position resolution and the recorded distributions of the first and second light emissions are compared with expected distributions. Here as well, based on the comparison result, the document of value may be deemed authentic or it may be deduced that manipulation has taken place.

### BRIEF DESCRIPTION OF THE DRAWINGS

Further exemplary embodiments and advantages of the invention are explained below with the aid of the figures, the representation of which was not to scale and not accurately proportioned in order to improve the clarity.

In the drawings:

FIG. 1, including FIGS. 1(a) to 1(c), schematically shows in 1(a) a banknote according to one exemplary embodiment of the invention and in 1(b) and 1(c) counterfeited banknotes obtained by a detachment attack,

FIG. 2 shows a foil patch according to the invention in cross section,

FIG. 3 shows the foil patch of FIG. 2 after the application onto the paper substrate of a banknote and the peeling-off of the transfer foil,

FIG. 4 shows a foil patch according to another exemplary embodiment of the invention on a banknote,

FIG. 5 shows a foil patch according to a further exemplary embodiment of the invention on a banknote, before the transfer carrier is peeled off,

FIG. 6, including FIGS. 6(a) to 6(c), schematically shows in (a) a banknote according to another exemplary embodiment of the invention and in (b) and (c) counterfeited banknotes obtained by a detachment attack,

FIG. 7 shows a window security thread, which is embedded into a banknote, according to one exemplary embodiment of the invention schematically in cross section, and

FIG. 8 shows a window security thread, which is embedded into a banknote, according to a further exemplary embodiment of the invention schematically in cross section.

### DETAILED DESCRIPTION OF VARIOUS EMBODIMENTS

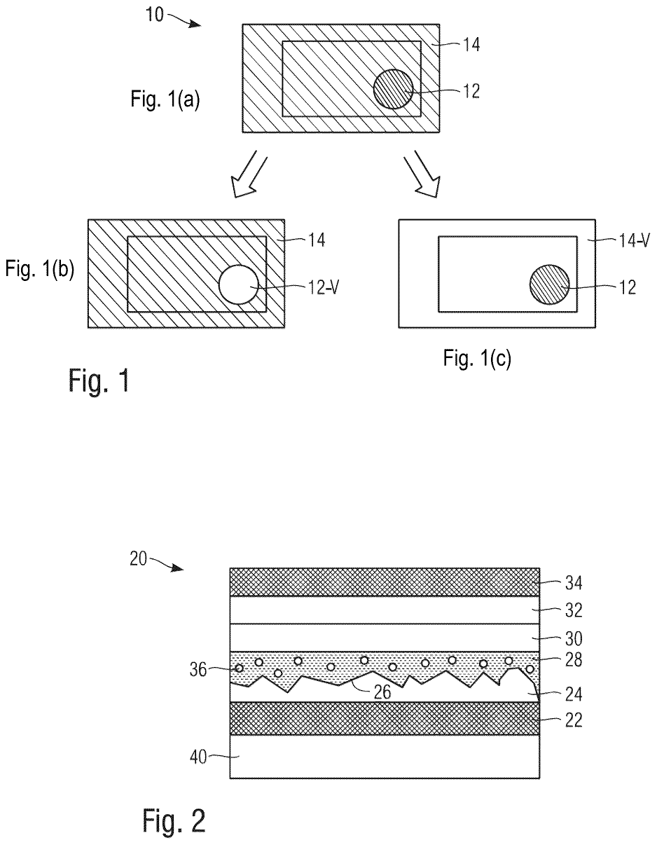

The invention is now explained with reference to the example of banknotes. FIG. 1 in this regard shows in FIG. 1(a) a banknote 10 according to the invention, which is equipped with a foil patch 12 having an optically variable appearance.

The foil patch 12 contains for protection a first machine-readable feature material in the form of an IR luminescent material or an optical storage phosphor with optically stimulated emission, the particular location of the feature material in the foil patch 12, which is described in more detail further below, ensuring that the feature material is removed fully from the banknote 10 in the event of a detachment attack (“harvesting”).

The paper substrate 14 of the banknote 10 contains a second machine-readable feature material, which is likewise formed by an IR luminescent material or an optical storage phosphor with optically stimulated emission.

In the course of a detachment attack, the genuine foil patch 12 is typically removed from the genuine banknote 10 and replaced with a counterfeit 12-V, as shown in FIG. 1(b), while the genuine foil patch 12 is transferred onto a counterfeited banknote substrate 14-V, as represented in FIG. 1(c).

During the machine authenticity verification of the banknotes, the presence both of the first and of the second feature material is verified and the authenticity of a note is confirmed only in the event that both feature materials are demonstrated. The banknote 10 of FIG. 1(a) is therefore recognized as genuine, while although the counterfeit of FIG. 1(c) contains the genuine foil patch 12, the manipulation can be recognized by the absence of the second feature material in the paper substrate 14-V.

The counterfeit of FIG. 1(b) can be rejected because of the absence of the first feature material in the region of the counterfeited foil patch 12-V, since the first feature material has been removed from the banknote substrate 14 without leaving residue when detaching the genuine foil patch 12.

The structure and the functionality of security elements according to the invention and of documents of value according to the invention are now explained in more detail with reference to the following figures.

FIG. 2 in this regard shows a foil patch 20 according to the invention in cross section. The foil patch 20 is a multilayer stack, which is typically constructed on a transfer foil 40 that is peeled off again during the subsequent application of the patch onto a target document.

A first UV varnish layer 22 is initially applied on the transfer foil 40 as a release layer, which is simultaneously used as a print-accepting layer for subsequent printing. A UV embossing varnish layer 24, in which the optical structures for the desired optically variable appearance are embossed, is applied on the UV varnish layer 22.

The recognizability of the optical structures is enhanced in the exemplary embodiment by a reflection-increasing coating 26, which may in particular be formed by a metal layer, by a high-index layer or an interference layer structure. The UV embossing varnish layer 24 with the embossed optical structures forms together with the reflection-increasing coating 26 the optical functional layer of the foil patch 20.

A thin PET foil 30 having a thickness of between 4 μm and 15 μm is laminated onto the reflection-increasing coating 26 of the optical functional layer with a laminating adhesive 28 as a foil sheet. A primer layer 32 and finally an adhesive layer 34, preferentially a heat-sealing varnish, for the connection to the target substrate, are also applied onto the PET foil 30.

The first machine-readable feature material 36 in the exemplary embodiment of FIG. 2 is mixed with the laminating adhesive 28 and therefore lies like the optical functional layer 24, 26 on the upper side of the PET foil 30.

Before and/or after the lamination of the PET foil 30, further functional layers having further authenticity features such as fluorescence, IR, magnetism, conductivity, polarization effects, colored inks and effect inks may also be introduced.

The foil patch may subsequently be defined by stamping and released by slitting and winding. The stamping step may also be omitted in order to produce a security element in the form of a continuous foil strip. Gradual transitions in the geometrical extent up to the full height of the banknote are also possible. Strip cutting may subsequently take place in order to produce a coil material from the foil material.

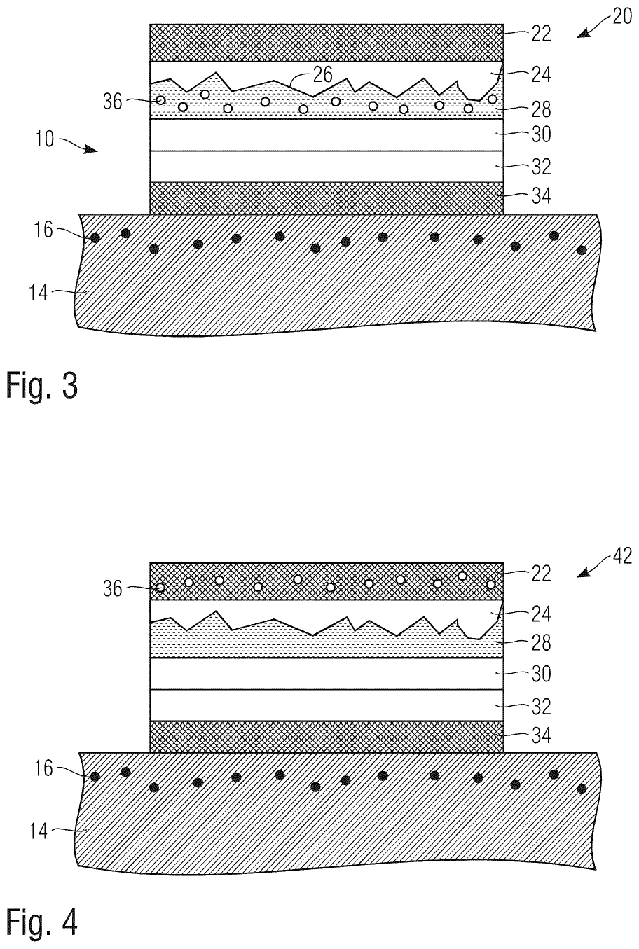

FIG. 3 shows the foil patch 20 of FIG. 2 after the application onto the paper substrate 14 of a banknote, for instance of the banknote 10 of FIG. 1. The carrier foil 40 was peeled off after the application of the foil patch so that the UV varnish layer 22 as the topmost layer can now function as a print-accepting layer.

The paper substrate 14 of the banknote 10 is provided with a second machine-readable feature material 16, which together with the first machine-readable feature material 36 of the foil patch completes the protection of the banknote.

The foil patch 20 is stabilized by the internal foil sheet 30 and thereby has the effect that the foil sheet 30, and therefore also all layers arranged above the foil sheet 30, are also removed from the banknote 10 together with the optical functional layer 24, 26 in the event of a detachment attack. This ensures that the feature material 36 arranged in the laminating adhesive layer 28 is removed fully from the banknote 10 in the event of a detachment attack. No residue of feature material 36 therefore remains on the banknote 10, so that the latter can reliably be recognized as having been manipulated even after it is equipped with a counterfeited foil patch 12-V (FIG. 1(b)).

For the first and second machine-readable feature materials 16, 36, the advantageous materials described above may in particular be used. For example, the feature materials 16, 36 may be two IR-IR luminescent materials which have a common spectral band in the excitation spectrum and at the same time different separate spectral bands in the emission spectrum. This allows the simultaneous excitation of the two feature materials 16, 36, for instance with a single light source and separate detection, for example in two different spectral channels in a single combination sensor, so that the two IR-IR luminescent materials can be detected independently of one another.

As revealed by the explanation above, the first machine-readable feature material 36 may be introduced into any layer lying on the upper side of the foil sheet 30 or alternatively into the foil sheet 30 itself. FIG. 4 shows by way of example a foil patch 42 according to another exemplary embodiment of the invention, in which, in contrast to the foil patch 20 of FIGS. 2 and 3, the first feature material 36 is present in the UV varnish layer 22.

In the exemplary embodiment of FIG. 4, the feature materials 16, 36 may also be two IR-IR luminescent materials. Advantageously, however, in this embodiment an optical storage phosphor with optically stimulated luminescence, which is excited and read out in the visible or UV, may also be selected as the first feature material 36, since because the first feature material 36 is arranged above the optical functional layer 24, 26 there is no risk of interfering absorption by a reflection-increasing coating, in particular by a metallization of the optical functional layer.

The second feature material 16 may then likewise be an optical storage phosphor or alternatively an IR luminescent material.

It is understood that, in other exemplary embodiments, the first machine-readable feature material 36 may also be introduced in the UV embossing varnish layer 24 or into the foil sheet 30 itself. The first feature material 36 may also be present of a dedicated feature layer arranged on the upper side of the foil sheet 30. Such a dedicated feature layer may be present surface-wide, as a motif/pattern, or only in the future product regions. A dedicated feature layer may be provided as a UV-curing layer or a solvent-based layer. Since the first feature material 36 in all these variants is arranged on the upper side of the foil sheet 30, the first feature material 36 is always removed fully together with the foil sheet 30 and the optical functional layer 24, 26 in the event of a detachment attack.

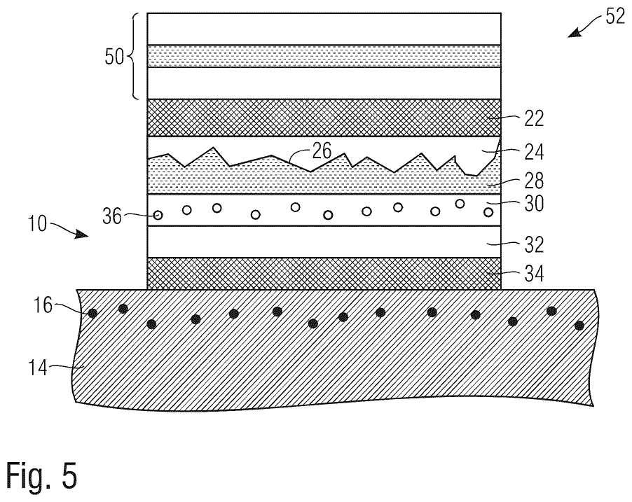

FIG. 5 shows as a further exemplary embodiment a banknote 10 having a second feature material 16 introduced into the paper substrate 14 and having a foil patch 52, which is applied onto the paper substrate and in which the first feature material 36 is introduced into the foil sheet 30 itself. In the figure, the foil patch 52 is shown immediately after the application onto the banknote, before the transfer carrier 50 consisting of two partial foils laminated together is peeled off.

In order to demonstrate the advantages achieved by the invention, a foil security element according to the invention and a comparison element not according to the invention were each applied onto a protected substrate and the demonstrability of a detachment attack was verified.

### Exemplary Embodiment 1

In a foil patch having a structure as in FIG. 2, a luminescent marker A which can be excited in the near infrared (NIR) and emits in the near infrared is used as the first feature material. The luminescent marker A is for this purpose dispersed in a laminating adhesive in a ball mill and spread in a 12 μm wet film thickness onto a semifinished product of a metallized micromirror patch, and the metallized micromirror patch is connected to a 12 μm thin PET foil sheet.

The layer sequence produced in this way was initially spread with a primer layer and was then adhesively bonded by means of a heat-sealing adhesive onto a banknote paper provided with an IR luminescent marker B (NIR/NIR), and the transfer foil was peeled off.

The luminescent marker B forms the second feature material 16 of FIG. 3, and the first feature material 36 is formed by the luminescent marker A which is present in the laminating adhesive layer between the optical functional layer, in the present case the metallized micromirrors, and the PET foil sheet.

The luminescent intensities of the marker A and of the marker B were measured with a luminescence sensor for banknote applications from the rear side of the banknote (“Original document” in Table I). The foil patch was subsequently removed from the banknote and adhesively bonded with adhesive tape onto a blank sheet which constitutes the recipient document. The corresponding luminescent intensities of the donor document after the detachment and of the recipient document were measured again:

TABLE I

| | | Donor | Recipient |
|---|---|---|---|
| | Original | document after | document after |
| | document | detachment | transfer |
| Luminescent intensity A | 100% | 0% | 45% |
| Luminescent intensity B | 100% | 100% | 0% |

As may be seen from Table I, the luminescent intensity A vanishes completely during the detachment process, and the donor document can therefore reliably be recognized as having been manipulated. The recipient document can also reliably be recognized as a counterfeit because of the absence of the luminescent intensity B.

### Comparative Example 1

The comparison element has the same basic structural layout as the foil patch according to the invention, although the luminescent marker A in the comparison element was introduced into the primer layer of the substrate adhesive on the lower side of the PET foil sheet.

The detachment and transfer process described above is repeated and the luminescent intensities are measured:

TABLE II

| | | Donor | Recipient |
|---|---|---|---|
| | Original | document after | document after |
| | document | detachment | transfer |
| Luminescent intensity A | 100% | 16% | 40% |
| Luminescent intensity B | 100% | 100% | 0% |

As may be seen from Table II, the luminescent intensity A does not vanish fully from the donor document in the comparative example, in contrast to the embodiment according to the invention, since a part of the primer layer remains on the donor document during the detachment process. The donor document cannot therefore reliably be recognized as having been manipulated in the comparative test.

The invention may be used not only in the case of wide security elements applied onto a document of value, for instance the foil patch of FIGS. 1 to 5, but also in the case of narrow security threads introduced at least partially into the substrate of a document of value.

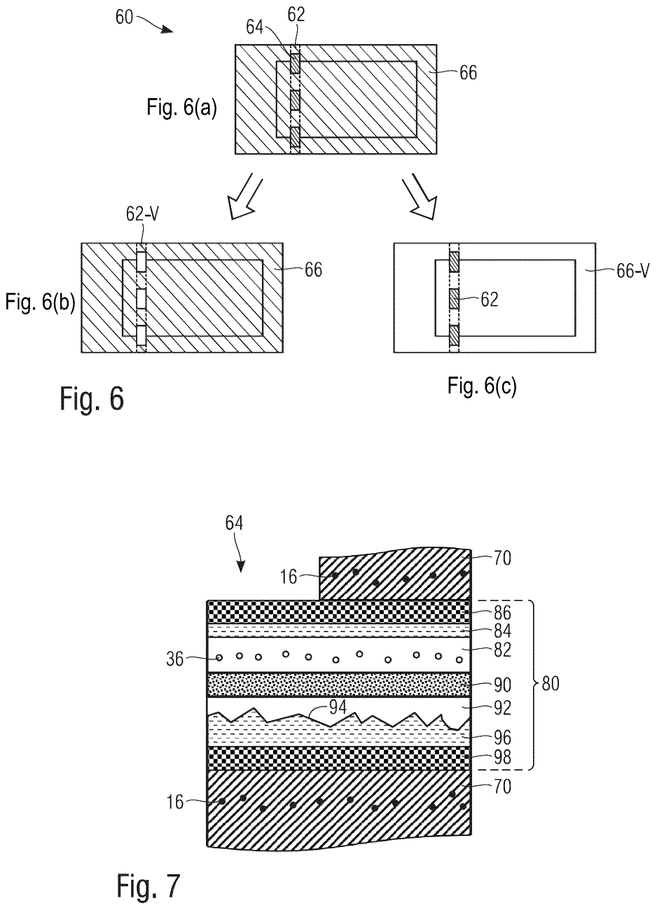

FIG. 6 in this regard shows in FIG. 6(a) a banknote 60 according to the invention, which is provided with an optically variable window security thread 62 that emerges at particular window regions 64 on the surface of the banknote, while in the regions lying between them it is embedded in the interior of the banknote.

The window security thread 62 contains for protection a first machine-readable feature material in the form of an IR luminescent material or an optical storage phosphor with optically stimulated emission. In this embodiment as well, the location of the feature material in the window security thread 62 ensures that the feature material is removed fully from the banknote 60 in the event of a detachment attack.

The paper substrate 66 of the banknote 60 contains a second machine-readable feature material, which is likewise formed by an IR luminescent material or an optical storage phosphor with optically stimulated emission.

In the course of a detachment attack, the genuine window security thread 62 is typically removed from the genuine banknote 60 and replaced with a counterfeit 62-V, as shown in FIG. 6(b), while the genuine window security thread 62 is transferred into a counterfeited banknote substrate 66-V, as represented in FIG. 6(c).

During the machine authenticity verification of the banknotes, the presence both of the first and of the second feature material is verified and the authenticity of a note is confirmed only in the event that both feature materials are demonstrated. The banknote 60 of FIG. 6(a) is therefore recognized as genuine, while although the counterfeit of FIG. 6(c) contains the genuine window security thread 62, the manipulation can be recognized by the absence of the second feature material in the paper substrate 66-V. The counterfeit of FIG. 6(b) can be rejected because of the absence of the first feature material in the region of the counterfeited window security thread 62-V, since the first feature material has been removed from the banknote substrate 66 without leaving residue when removing the genuine window security thread 62.

For further explanation, FIG. 7 shows a schematic cross section of a window security thread 80 which is embedded into the security paper 70 of a banknote.

The security thread 80 is a multilayer stack having an internal transparent foil carrier 82. The foil carrier 82 is provided on a first side with a first primer layer 84 and a first adhesive layer 86, in particular a heat-sealing varnish layer. On the opposite second side, the foil carrier 82 is provided with a first UV varnish layer 90 as priming and a UV embossing varnish layer 92, which is arranged directly on the UV varnish layer 90 and in which the optical structures for the desired optically appearance of the security thread are embossed.

The recognizability of the optical structures is enhanced by a reflection-increasing coating 94, which may for example be formed by a metal layer, a high-index layer or an interference layer structure. The UV embossing varnish layer 92 with the embossed optical structures forms together with the reflection-increasing coating 94 the optical functional layer of the security thread 80.

A second primer layer 96 and a second adhesive layer 98, preferentially a heat-sealing varnish, for anchoring in the security paper 70 are also applied onto the reflection-increasing coating 94.

In the exemplary embodiment of FIG. 7, the first machine-readable feature material 36 is present in the transparent foil carrier 82 itself, while the second machine-readable feature material 16 is present in the paper substrate 70 of the banknote 60 and together with the first machine-readable feature material 36 of the security thread 80 completes the protection of the banknote.

The introduction of the second machine-readable feature material 16 into the paper substrate 70 advantageously takes place in the paper machine during the paper production, where the security thread 80 is incorporated between two sheets (main former, short former) into the wet paper web and anchored there during the paper production. The windows 64 of the window security threads are created by gaps in one of the two paper sheets, so that paper fibers locally do not accumulate there.

In the event of a detachment attack in which the thread 80 is extracted from the banknote 60, the foil carrier 82 and therefore the feature material 36 introduced in the foil carrier 82 are necessarily also removed fully together with the optical functional layer 92, 94 from the banknote 60. The latter can therefore reliably be recognized as having been manipulated even after it is possibly equipped with a counterfeited window security thread 62-V (FIG. 6(b)).

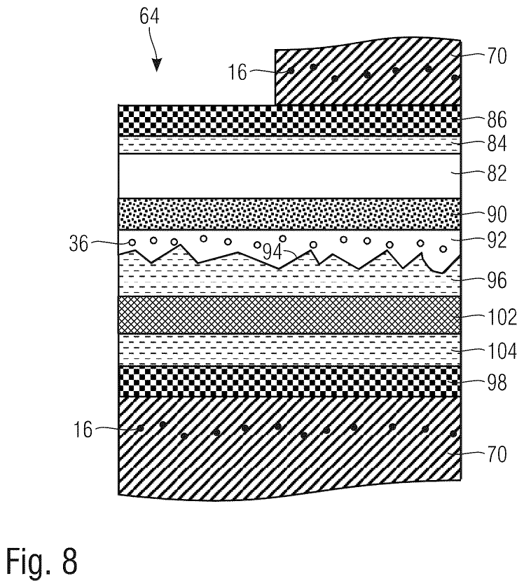

FIG. 8 shows a further exemplary embodiment, in which the security thread 100 is equipped with an additional functional layer 102. The security thread 100, like the security thread 80 of FIG. 7, is a window security thread which is partially embedded into the security paper 70 of a banknote.

The security thread 100 is a multilayer stack having an internal transparent foil carrier 82, which is constructed substantially in the same way as the security thread 80 of FIG. 7, that is to say it carries a first primer layer 84 and a first adhesive layer 86 on a first side of the foil carrier 82 and is provided on the second side of the foil carrier 82 with a first UV varnish layer 90, a UV embossing varnish layer 92 arranged directly on the UV varnish layer 90, a reflection-increasing coating 94, a second primer layer 96 and a second adhesive layer 98.

Unlike in the simpler embodiment of FIG. 7, a functional layer 102 and a third primer layer 104 are also additionally provided between the two elements mentioned last. The functional layer 102 may for example be a magnetic pigment layer or a fluorescent pigment layer. The functional layer is advantageously arranged, as also shown in FIG. 8, below the reflection-increasing coating 94 as seen from the main observation direction (from above in FIG. 8). FIG. 8 shows a surface-wide embodiment of the functional layer 102, although in other embodiments it may also be structured.

The first machine-readable feature material 36 is present in the exemplary embodiment of FIG. 8 in the UV embossing varnish layer 92, while the second machine-readable feature material 16 is introduced into the paper substrate 70 of the banknote 60 and together with the first machine-readable feature material 36 of the security thread 100 completes the protection of the banknote.

In the event of a detachment attack in which the thread 100 is extracted from the banknote 60, the UV embossing varnish layer 92 as part of the optical functional layer 92, 94 is necessarily likewise removed so that the feature material 36 that has been introduced is also removed fully from the banknote 60. The latter can therefore reliably be recognized as having been manipulated even after it is equipped with a counterfeited window security thread 62-V (FIG. 6(b)).

In a security thread, the first feature material 36 is advantageously present in a layer which is optically necessary for the appearance and is transferred as fully as possible in the event of the manipulative removal of the security thread. The full transfer is ensured in particular when the feature material is used in the foil carrier 82. Optical protection is nevertheless also obtained when the feature material 36 is used in the UV primer layer 90 or in the UV embossing varnish 92, since these layers are connected inseparably to the foil carrier 82. In the case of security threads which contain liquid crystals, the feature material 36 may also be added to the liquid crystal formulation. In the case of multilayer threads, use in the laminating adhesive may also be advantageous.

### Exemplary Embodiment 2

In a window security thread having a structure as in FIG. 7, a luminescent marker A which can be excited in the near infrared (NIR) and emits in the near infrared is used as the first feature material. The luminescent marker A is for this purpose dispersed in a primer varnish in a ball mill and spread directly in a 12 μm wet film thickness onto a semifinished product of a metallized micromirror security thread following the metallization. A heat-sealing varnish is subsequently spread, the semifinished product is cut into a 3 mm wide security thread and introduced into a banknote paper.

The banknote paper contains a luminescent marker B which can be excited in the near infrared (NIR) and emits in the near infrared and can be excited at the same NIR wavelength as the luminescent marker A. The luminescent marker B forms the second feature material 16 of FIG. 7, and the first feature material 36 is formed by the luminescent marker A.

The luminescent intensities of the marker A and of the marker B are measured with a luminescence sensor for banknote applications from the rear side of the banknote (“Original document” in Table III). The respective maximum is used as a metric for the luminescent intensity of A, and the median of all the measurement points is used for B. The intensities were and respectively normalized to their initial value.

The security thread is subsequently removed from the banknote by cutting and adhesively bonded with adhesive tape onto a blank sheet (“Recipient document”). The corresponding luminescent intensities are measured again:

TABLE III

| | | Donor | Recipient |
|---|---|---|---|
| | Original | document after | document after |
| | document | detachment | transfer |
| Luminescent intensity A | 100% | 0% | 100% |
| Luminescent intensity B | 100% | 100% | 0% |

As may be seen from Table III, the luminescent intensity A vanishes completely during the detachment process and the donor document can therefore reliably be recognized as having been manipulated. The recipient document can also reliably be recognized as a counterfeit by the absence of the luminescent intensity B.

1.-17. (canceled)

18. An optically variable security element for protecting a document of value, having a first machine-readable feature material and an optical functional layer, which imparts an optically variable appearance to the security element when viewed,
wherein the security element is formed in multiple layers with an internal foil sheet, which has a first side and an opposite second side, the foil sheet being provided at least on the first side with an adhesive layer for connection to the document of value and on the second side with the optical functional layer, and the first machine-readable feature material being arranged in the foil sheet or on the second side of the foil sheet.

19. The security element according to claim 18, wherein the first machine-readable feature material is an IR luminescent material or an optical storage phosphor with optically stimulated luminescence.

20. The security element according to claim 18, wherein the first machine-readable feature material is present in a feature layer arranged on an upper side of the foil sheet, in a UV-curable varnish layer, an embossing varnish layer or an adhesive layer.

21. The security element according to claim 18, wherein the foil sheet is formed by a foil with a thickness of between 4 μm and 15 μm, for example a PET foil.

22. The security element according to claim 18, wherein the optical functional layer is formed by a hologram or another diffraction structure, an interference structure, a matt structure, a micromirror arrangement, a microlens arrangement, a moth-eye structure, a subwavelength structure or a combination of these elements.

23. The security element according to claim 18, wherein the optical functional layer has a reflection-increasing coating, a metal layer, a high-index layer and/or a color-shifting interference coating.

24. The security element according to claim 18, wherein the first machine-readable feature material is an IR luminescent material that emits in a near-infrared spectral range, with a wavelength range of between 400 nm and 2100 nm.

25. The security element according to claim 18, wherein the security element is a security thread, in a window security thread or a rolling security thread, or a patch or label for application onto a document of value.

26. A document of value having an optically variable security element according to claim 18,
wherein the optically variable security element is connected by the adhesive layer arranged on the first side of a foil element to a substrate of the document of value, and
wherein the substrate of the document of value contains a second machine-readable feature material, in an IR luminescent material or an optical storage phosphor with optically stimulated luminescence.

27. The document of value having an optically variable security element according to claim 18,
wherein the optically variable security element is a security thread embedded at least partially into the document of value, and
wherein the substrate of the document of value contains a second machine-readable feature material, in an IR luminescent material or an optical storage phosphor with optically stimulated luminescence.

28. The document of value according to claim 26, wherein the first and the second feature material is in each case an IR luminescent material, the first and second IR luminescent materials advantageously having different emission spectra and/or different excitation spectra.

29. The document of value according to claim 28, wherein the first and the second IR luminescent material have at least one common spectral band in the emission spectrum and at the same time separate spectral bands in the excitation spectrum.

30. The document of value according to claim 28, wherein the first and the second IR luminescent material have at least one common spectral band in the excitation spectrum and at the same time separate spectral bands in the emission spectrum.

31. The document of value according to claim 26, wherein the first and the second feature material is in each case an optical storage phosphor, the first and second optical storage phosphor advantageously being chargeable together and readable differently.

32. The document of value according to claim 26, wherein one of the two feature materials is an IR luminescent material and the other of the two feature materials is an optical storage phosphor.

33. A method for verifying a document of value according to claim 27, in which the presence of the first feature material in the optical variable security element and the presence of the second feature material in the substrate of the document of value are recorded with position resolution using a machine, and the recorded distributions of the first and second feature materials are compared with expected distributions.

34. A method according to claim 33 for verifying a document of value wherein the first and the second IR luminescent material have at least one common spectral band in the excitation spectrum and at the same time separate spectral bands in the emission spectrum, in which the substrate of the document of value and the security element are illuminated with excitation light which contains a wavelength of the common spectral band of the excitation spectrum of the first and of the second IR luminescent material, the light emissions of the first and of the second IR luminescent material are each recorded with position resolution and the recorded distributions of the first and second light emissions are compared with expected distributions.
